(19) United States
(12) Patent Application Publication
(10) Pub. No.: US 2021/0137027 A1
(43) Pub. Date: May 13, 2021

(54) MODULAR PLANT GROWING SYSTEM

(71) Applicant: Mr. Leslie David Howe, Ottawa (CA)

(72) Inventor: LESLIE DAVID HOWE, Ottawa (CA)

(73) Assignee: SOUTHPAC TRUST INTERNATIONAL INC., TRUSTEE OF THE LDH TRUST, RAROTONGA (CK)

(21) Appl. No.: 16/986,394

(22) Filed: Aug. 6, 2020

Related U.S. Application Data
(60) Provisional application No. 62/883,976, filed on Aug. 7, 2019.

(51) Int. Cl. A01G 9/24

(52) U.S. Cl. CPC A01G 9/249

(57) ABSTRACT

A modular plant growing system may comprise two or more substantially vertical light panels, wherein each substantially vertical light panel may comprise one or more LED light engines. A support base may be attached directly or indirectly to each vertical light panel, wherein the support bases may be configured to engage with bottom surfaces of plant growing containers. Optional one or more top reflection panels may be configured to be disposed above the two or more substantially vertical light panels, the one or more top reflection panels may comprise reflection material and at least one ventilation opening. A plant growing space may be provided in the space defined by the two or more substantially vertical light panels and the one or more optional top reflection panels.

### RELATED APPLICATIONS

This application claims the benefit of the following United States Provisional Patent Applications, the contents of which are incorporated by reference in their entirety as if set forth in full: U.S. Provisional Patent Application No. 62/883,976, entitled “Modular Plant Growing System,” filed Aug. 7, 2019.

### TECHNICAL FIELD

This disclosure generally relates to growing systems for plants.

### BACKGROUND

There is a continuing need for horticulture systems that can save energy and increase yields in horticulture applications.

### BRIEF DESCRIPTION OF THE FIGURES

FIG. 1 shows a perspective view of an example embodiment of a modular plant growing system comprising four modules, with plants disposed inside.

FIG. 2 shows an mirror perspective view of the example embodiment of a modular plant growing system shown in FIG. 1, but without the plants disposed inside.

FIG. 3 shows a perspective view of the example embodiment of a modular plant growing system shown in FIG. 2 with light panels shown in their collapsed state, with plants disposed inside.

FIG. 4 shows a perspective view of the example embodiment of a modular plant growing system shown in FIG. 3 with light panels shown in their collapsed state, with no plants disposed inside.

FIG. 5 shows a perspective view of two modules of an example embodiment of a modular plant growing system without removable top panels.

FIG. 6 shows a mirror perspective view of the two modules of an example embodiment of a modular plant growing system shown in FIG. 5.

FIG. 7A and FIG. 7B shows two perspective views of two modules of an example embodiment of a modular plant growing system without removable top panels, and without collapsible light panels.

FIG. 8A and FIG. 8B shows two exploded perspective views of two modules of an example embodiment of a modular plant growing system without removable top panels, and without collapsible light panels as shown in FIG. 7A and FIG. 7B.

FIG. 9 shows an example embodiment of collapsible light panel in its extended state.

FIG. 10A and FIG. 10B shows two perspective views of an example embodiment of collapsible light panel in its collapsed state.

FIG. 11A shows a perspective view of a portion of an example embodiment of collapsible light panel comprising a single light engine and two sections of reflection material.

FIG. 11B shows a profile view of a portion of an example embodiment of collapsible light panel comprising a single light engine and two sections of reflection material.

FIG. 12 shows a close up profile view of a portion of an example embodiment of collapsible light panel comprising a single light engine and two sections of reflection material.

FIG. 13 shows a top profile view of an example embodiment of collapsible light panel that is slidingly engaged with a flange of a vertical support member. Various ancillary elements have been removed for illustrative purposes.

FIG. 14 shows a profile view of an example embodiment of light engine showing a general representation of light ray propagation within the light engine.

FIG. 15 shows a profile view of an example embodiment of modular plant growing system showing a general representation of light ray propagation within the modular plant growing system.

FIG. 16 shows a perspective view of a removable top panel.

FIG. 17 shows a profile view of an example embodiment of modular plant growing system wherein the two left vertical support member are removed for illustrative purposes.

FIG. 18 shows a profile view of the air and gas flow within an example embodiment of modular plant growing system.

### DETAILED DESCRIPTION

Both indoor growing and greenhouse cannabis growing each may have their own advantages and disadvantages, and each may have their methods and practices of cultivation, especially with respect to lighting. Typically greenhouse growing may use sunlight as the main light source, and supplement this light with artificial lighting. Indoor growing may typically rely solely on artificial lighting. Regardless of whether the growing method is greenhouse or indoor, the supplemental lighting may typically be hung overhead at a relatively large distance from the canopy of the plants. The potential disadvantages of this method of lighting are many and well known in the art, and will not be discussed here for brevity. Additionally, there may be other improvements that may serve to increase plant yields and save on energy, as may be subsequently discussed.

Using the overhead lighting method as previously described with cannabis plants, the plants may form dense canopies that make it difficult for adequate light penetration beneath it. As a result, the number and quality of colas in those lower regions of the plants may be diminished. If light could be distributed more homogenously across the entire plant, the plant yield (commercially saleable cannabis products) may also increase. Accordingly, an LED lighting system that could supply adequate light levels from the side of plants as well as from the top, and would not functionally interfere with the growing techniques utilized, may be advantageous.

If such a side lighting LED lighting apparatus did exist, it may comprise rigid panels or other apparatus that may interfere with access to the plants with respect to the inspection and maintenance of the plants. If a novel lighting apparatus could be devised that would evenly light the sides and tops of the plants as well as allow full access to the plants, such an apparatus may be very advantageous.

The leaf surface temperature (LST) may be an important factor in optimizing cannabis yields. There may be prevailing industry acceptance that using HPS light fixtures, 75 degree F. may be the optimal ambient air temperature. However, HPS lights may include a substantial amount of infrared light which may raise the LST by up to 10 degrees. LED lighting may include little or negligible infrared light, which may require the ambient room temperature to be increased by a proportional amount. Considering hot air rises, it may take a considerable amount of energy to keep such a higher ambient temperature, especially in colder climates or seasons. An LED lighting system that could supply this extra required heat may indeed be advantageous. Furthermore, such a system that could adjust the degree of extra heat would may be even more advantageous.

Sufficient carbon dioxide levels and the distribution thereof may also be an important factor in achieving optimal yields. When carbon dioxide is injected into a growing environment, it may sink to the lowest levels of the grow room due to the molecules increased density relative to air. Many fans may need to horizontally blow across the grow environment to evenly distribute the carbon dioxide adequately. If a novel lighting apparatus could include a passive system of ventilation, that functioned similarly to what may occur with the “stack effect” or “chimney effect” that could continuously and evenly circulate air and carbon dioxide from regions near the ground or floor towards regions above the plants, this may evenly distribute carbon dioxide evenly around the plants and may be of great benefit.

If a novel lighting apparatus could be devised that surrounded plants and also had a means for even distribution of injected carbon dioxide around the plants, this may offer substantial benefits.

If a novel lighting apparatus could be devised that was able to be disposed on the floor instead of being hung from the ceiling, yet only take up a negligible amount of floors space, and also be modular, that may also be very advantageous.

If a novel lighting apparatus could be devised that was able to utilize the weight of potted plants as a structural elements, this may minimize the footprint of the apparatus, as well as the size, weight and complexity of the apparatus. This may be very advantageous.

If a novel side and top lighting apparatus as described could be easily adjusted in height to accommodate different plant heights, this would also be of great benefit.

Importantly, if a novel side and top lighting apparatus as described could equally function both in a greenhouse application as a supplemental light source as well as the primary or only light source in an indoor grow environment, that would indeed be of valuable benefit.

Embodiments of the claimed invention that will subsequently be described may embody some or all of the beneficial or advantageous qualities as previously described.

Although various embodiments of the invention may be described with respect to cultivating cannabis, this is for illustrative purposes only, and should not be construed to limit the scope of possible applications for the various embodiments of the invention. The written descriptions may use examples to disclose certain implementations of the disclosed technology, including the best mode, and may also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

An example embodiment of a novel modular plant growing system (“MPGS”) is shown in FIG. 1. FIG. 2 shows the same example embodiment as shown in FIG.1 from the opposite perspective, and without the plants 8. The MPGS comprises four modules as denoted by features A through D. Module A may connect end to end with module B, as may module C and module D. As shown, modules C and D may share sides with modules A and B which may enable a plurality of continuous rows with no aisles, which may enable more efficient usage of valuable growing space. Each module may comprise a base 4, an electrical enclosure 9, a collapsible light panel 3, a removable top panel 1, and vertical supports 7. A top panel 1 may comprise a reflector 2 and one or more fans 10. One or more plants 8 may be placed wherein the plants may be disposed on bases 4. This novel feature may enable example embodiments of MPGS to remain stable in an upright position by utilizing the considerable mass of potted plants as ballast. Without this, considerably more structural support features may be need to maintain the same stability, which may increase manufacturing cost, as well as increase the footprint of example embodiments of MPGS. The MPGS or modules may also comprise one or more irrigation tubes 11 and one or more CO2 tubes 12.

As shown, the light panels 3 may be two sided, wherein light engines 5 and reflector material 6 may be disposed on both sides of a light panel 3. This novel feature may allow more efficient usage of the growing space. In applications where a light panel 3 may be disposed on the outside row of a growing space wherein no plants are located on a side of the light panel 3, the light panel 3 may be configured with light engines on only one side of the panel.

Each module may comprise a removable top panel 1, which may further comprise one or more fans 10, and a reflector panel 2.

FIG. 3 shows the same example embodiment as shown in FIG. 2, except that in FIG.3 the light panels 3 may be disposed in their collapsed mode, and plants 8 are disposed inside the MPGS. FIG. 3 may be identical to FIG. 4 with the exception of the plants 8 being absent in FIG. 4.

FIG. 5 shows an example embodiment of a double module (feature A and B) connected end to end, without plants or top panels. For clarity, “module” may refer to a single section with a collapsible light panels with light engines on one or both sides. As shown in FIG. 1, plant rows in side by side rows may share module sides. As shown in FIG. 5, each module may comprise a base 4, an electrical enclosure 9, a collapsible light panel 3, a removable top panel 1 (not shown), and vertical supports 7. The modules may also comprise one or more irrigation tubes 11 and CO2 tubes 12.

FIG. 6 shows a perspective view from the opposite side as shown in FIG, 5. Each module may comprise a base 4, an electrical enclosure 9, a collapsible light panel 3, a removable top panel 1 (not shown), and vertical supports 7. The MPGS may also comprise one or more irrigation tubes 11 and CO2 tubes 12.

FIG. 7A and FIG. 7B shows opposite perspective views of an example embodiment of a single module A. Module A may comprise a base 4, an electrical enclosure 9, and vertical supports 7. The module A may also comprise a power connector 24, electrical cable 21, collapsible light panel support brackets 22, and electrical enclosure cover 20. Collapsible light panel support brackets 22 may allow example embodiments of collapsible light panels to be disposed at different heights, wherein the lighting may be optimized for different applications such as different plant heights and indoor growing vs greenhouse growing.

The power connector 24 supplied by the electrical cable 23 may allow power connecting cables to interconnect adjacent modules. This may have the advantages of keeping the electrical power cables away from the ground where moisture and interference with plant maintenance may be an issue. Additionally, this method of interconnection of modules may allow modules to be moved independently of adjacent modules while still remaining connected. Additional wires or connectors may be utilized in a similar fashion, such as sensor control circuits etc. The last module in a row of example embodiments of MPGS may advantageously be capable of connecting to a ceiling mounted power distribution node and or other controller nodes, thus keeping cabling off the floor or ground.

FIG. 8 shows an exploded view of the example embodiment of module shown in FIG. 7A and FIG. 7B. The module A may comprise a base 4, an electrical enclosure 9, and vertical supports 7. The module A may also comprise a power connector 24, electrical cable 21, collapsible light panel support brackets 22, electrical enclosure cover 20, power connector 24 and electrical cable 23. The electrical enclosure 9 may comprise an electrical enclosure raceway 26 along with electrical enclosure cover 20. LED drivers 27 and any other electrical wires or device may be disposed therein.

The module bases 4 may optionally comprise rollers 28, which may comprise any apparatus which may allow a module to be moved. This may be advantageous in applications where example embodiments of modules or MPGS may be needed to move for plant maintenance, harvest etc.

FIG. 9 shows an example embodiment of collapsible light panel which may comprise a top support member 30, reflection material sections 6, and light engines 5 which may further comprise a diffuser lens 31 and a heat sink 32. The reflection material 6 may comprise any reflection material that may be flexible enough to allow example embodiments of collapsible light panels to collapse. Such reflection material may comprise reflective optical film for example. The diffuser lenses 31 and heat sinks 32 will subsequently be described in greater detail later.

FIG. 10A and FIG. 10B shows opposite perspective views of an example embodiment of collapsible light panel as shown in FIG. 9, but in a collapsed state. FIG. 4 also shows example embodiments of collapsible light panels in their collapsed state. The example embodiment of collapsible light panel may comprise a top support member 30, reflection material 6, and light engine 5 which may further comprise a diffuser lens 31 and a heat sink 32. As shown, the reflection material 6 may fold, changing from a relatively planar state in FIG. 9 to a collapsed state in FIG. 10A and FIG. 10B, thus allowing example embodiments of collapsible light panels to collapse.

FIG. 11A shows a perspective view of a portion of an example embodiment of collapsible light panel with a double sided light engine, and FIG. 11B shows a profile view of the same.

Referring to FIG. 11B, in an example embodiment, reflection material 6A may comprise a fold 37 thus creating an end flap 33, the outer edge of which may engage an end flap retaining feature 38 configured in top support member 30. Any other suitable method of attaching reflection material to the top support member may also be utilized. For example, the reflection material 6A may be attached with fasteners, glue or clamping apparatus. The example embodiment also shows diffuser lens 31, heat sink 32, LED strip 34, reflection material 35, spacer 36, reflection material 6B and end flap 33 disposed thereon.

FIG. 12 shows a profile view an example embodiment of light engine. In use, the orientation of the light engine would be rotated 90 degrees clockwise.

The heat sinks 32 may comprise an aluminum extrusion that include channels to engage and secure the LED strips 34.

Two heat sinks may be configured back to back as shown, wherein two or more spacers 36 may function both to attach and secure the opposing heat sinks 32 together, as well as create an air gap to allow better thermal management of the heat emitted by the LED strips 34. Additionally, the gap created may create a guide track that may slidingly engage with corresponding flanges on the vertical supports. FIG. 13 is a top view looking straight down from above on one end of a module. All elements have been omitted for illustrative purposes except the vertical support 7, diffuser lenses 31, heat sinks 32, light panel support brackets and spacers 36. The guide track created may be shown as the gap between the two arrows GT. These guide tracks may be created on each end of each light engine of example embodiments of collapsible light panels. Accordingly, the guide tracks of an example embodiment of collapsible light panel may slidingly engage with the flange 7B of each vertical support 7, allowing light engines of the collapsible light panel to travel up and down along the flange 7B. In a fully extended state as shown in FIG. 9, the reflection material 6 may be disposed in a relatively planar state. In a collapsed state as shown in FIG. 10A, the reflection material may bend and “pool” thereby allowing each light engine to be disposed in close proximity to adjacent light engines, and thereby allowing a shorter overall height. Such a decrease in the overall height of example embodiments of collapsible light panel may allow easy access to plants disposed inside example embodiments of MPGS, as well as adjustments in the height of example embodiments of collapsible light panel.

Adjustments in the height of example embodiments of collapsible light panel may also be accomplished by configuring the light panels with less light engines 5 and reflection material sections 6 as shown in FIG. 9

Again referring to FIG. 12, the spacers 36 may be fastened with screws or any other suitable attachments method to the heat sinks 32. LED strips of any suitable type for a given application may be utilized.

Although example embodiments of light engines are shown with heat sinks 32 and LED strips 34 engaged in channels in the heat sinks 32, this should not be construed to limit the possibilities of variations of light engine configurations. Any light source with any suitable thermal management system may also be utilized. For example, individual high power LED modules may be configured on a heat sink. Alternate methods of connecting the reflection material 6 to the heat sinks 32 may be utilized, such as glue, crimping, fasteners, clips etc.

In example embodiments of light engine, diffusers 31 may be incorporated to enable the light to be diffused to some degree to allow a more even light dispersion with reduced hot spots. Although example embodiments of light engines are shown with diffusers 31, alternate diffuser systems may also be incorporated. Example embodiments may include alternate diffuser lens shape and size configurations. Example embodiments may include individual optical lenses over individual LEDs. Example embodiments may have no diffuser at all. Lens material may comprise acrylic or PC and may comprise diffusion particles disposed within the substrate, or disposed on one or more sides of the lens. Lens material may comprise optical diffusion film or lenticular lens films.

A novel method of light distribution in example embodiments of collapsible light panels is shown using the diffusers 31 and reflectors 35 in FIG. 12. FIG. 14 shows an example embodiment of light engine that may be disposed in the same orientation as would be utilized in actual use. Light emitted from LEDs 34 are shown by arrows, and may typically be emitted in a 120 degree FWHM beam angle. Direct light from the LEDs incident on diffuser lens 31 may refract through the diffuser lens 31. Light incident on the reflector 35 may reflect towards the diffuser lens 31 and refract through the diffuser lens 31. The reflector 35 may also reflect light reflected off the back side of diffusion lens 31 (bounce back) and back towards the diffuser lens, thus recycling a portion of the bounce back light. Preferably the reflector may comprise a high efficiency specular type material, such as an optical film reflection sheet. A diffusive reflector material may also be utilized, however the net efficiency of the light engine may be reduced somewhat.

FIG. 15 shows a side profile view of two side by side modules A with plants 8 disposed therein. All elements have been stripped away for illustrative purposes except the two collapsible light panels 3 in their fully extended state, and removable top panels 1. The collapsible light panels 3 may comprise light engines 5 and reflective material 6. Representative light rays which may show a typical dispersion pattern of light emitted by the light engines 5, are show by the arrows. Of note is the relatively even light dispersion on the plants 8, and the penetration of the light through the foliage of the plants. A majority of light not absorbed by the plants may be recycled by reflection material 6 and the top removable panels 1. Since light absorption of the plants 8 may have a high co-relation to the yield of the plants, especially cannabis plants, example embodiments of MPGS may increase plant yields very favorably. Also, due to the very close proximity of light source to the plants and the high degree of recycled light and low degree of wasted light, example embodiments of MPGS may exhibit a high degree of efficiency. Comparatively, typical plant light systems as previously described may be hung overhead of the plants. Accordingly, only the top canopy of the plants may receive the majority of the light, and plant yields may be lowered as a result. Additionally, light power necessarily may need to be higher due to the inverse square law of light, and a significant amount of light may be wasted by absorption by surfaces other than plant surfaces.

Again referring to FIG. 12, the diffuser lenses 31 made be configured from optical diffusion film or lenticular lens film. End flaps 33 may engage with the heat sinks 32 wherein the outer edges of the end flaps 33 may engage with the end flap retaining features 38 on the heat sinks 32. The reflection material 6 may be configured in a similar manner.

In example embodiments of MPGS, removable top panels (feature 1 on FIG. 1) may be attached to the top of the vertical supports 7. Referring to FIG. 16, example embodiments of removable top panels 1 may comprise frame members 40, reflection material 2, and one or more fans 10. The reflection material may comprise any reflection material previously discussed, and may be attached to the frame members utilizing methods previously discussed, or any other suitable method. The reflection material may also comprise rigid reflection panels, which may allow example embodiments of removable top reflection panels to not require frame members 40, which may save on manufacturing costs.

FIG. 17 shows a profile view of example embodiments of two side by side modules A and C of an example embodiment of MPGS. Two of the front vertical supports 17 have been removed for illustrative purposes. The light engines 5 of the collapsible light panels 3 may be slidingly engaged with the flanges 17B of the vertical supports 17. The vertical supports 17 may be attached to bases 4 and electrical enclosures 9. Removable top panels 1 may nest on top panel support cups 53, and comprise one or more fans 10. The example embodiment may also comprise one or more CO2 tubes 12 and irrigation tubes (not shown).

In example embodiments, a sensor array 50 with support wires or tube 51 may be disposed inside the MPGS. Sensors may include temperature sensors, humidity sensors, CO2 sensors etc. Sensors, if utilized, may be placed in any position within example embodiments of MPGS that may be beneficial, and may be mounted by any method that may be suitable. CO2 distribution hoses 12 may comprise valves that may be controlled by the sensors to allow preset CO2 levels to be maintained.

An important element for plant health and optimal yields is maintaining the proper temperature, CO2 level and humidity. A novel aspect of example embodiments of MPGS is the enclosed environment around the plants, which may allow a microclimate to be maintained, controlled and monitored. A diagram of this microclimate is shown in FIG. 18. In an example embodiment of MPGS, air flow may be influenced by the stack effect, wherein hot air rising from the LEDs (arrows denoted by LEDH) and venting out the fan openings may create an air pressure differential that may pull in cool air (arrows denoted by FR) that may enter the bottom openings on the MPGS. CO2 being emitted by the CO2 tubes 12 (arrows denoted by CO2) may be sucked upward due to this effect. The fans, when operating, may function to increase this stack effect, and when controlled by sensors, for example a temperature sensor, may allow a stable preset temperature to be maintained. The fan speed may also be controlled by a humidity sensor, thereby allowing the humidity levels to be controlled. Software or other control methods may be able to set a priority sequence setting wherein the temperature may control the fan speed between certain temperature ranges, and similarly with humidity ranges. This novel method of climate control may be very advantageous compared to controlling the same on a macro room level.

CO2 may be hard to distribute evenly on a macro room level. CO2, which may be heavier than air, may require series of fans in a room to blow the CO2 around the plants to get it where it will be most beneficial. In example embodiments of MPGS, the CO2 may be pulled upward thereby surrounding and bathing the plants with CO2. With cannabis plants, optimal CO2 levels may affect yields to a very significant degree, wherein this novel feature of example embodiments of MPGS may be extremely beneficial.

Humidity may also be controlled in a novel manner. In a manner similar to the distribution of CO2 as shown in FIG. 18, hoses with air that has been dehumidified (or humidified) may be distributed in hoses and the dispersion thereof be controlled by humidity sensors and control valves on the hoses. Humidity control may be an important element in cannabis production. For example, too much humidity may cause mold, blight or otherwise poor plant health conditions.

In an example embodiment of the described technology, a modular plant growing system may comprise two or more substantially vertical light panels, wherein each substantially vertical light panel may comprise one or more LED light engines. A support base may be attached directly or indirectly to each vertical light panel, wherein the support bases are configured to engage with bottom surfaces of plant growing containers. The modular plant growing system may further comprise optional one or more top reflection panels configured to be disposed above the two or more substantially vertical light panels, the one or more top reflection panels may comprise reflection material and at least one ventilation opening. A plant growing space may be provided in the space defined by the two or more substantially vertical light panels and the one or more optional top reflection panels.

In an example embodiment, the substantially vertical light panels may be light panels that are at least partially collapsible in the vertical direction.

In an example embodiment, the substantially vertical light panels may be light panels that are at least partially collapsible in the vertical direction, and may further comprise reflection material attached to the one or more LED light engines.

In an example embodiment, the one or more LED light engines may comprise lenses that direct the light predominantly at angles between 45 degrees and 0 degrees, wherein 45 degrees may represent the axis emanating from the normal of the LED light sources, and 0 degrees may represent the vertical axis of the one or more substantially vertical light panels.

In an example embodiment the one or more top reflection panels may comprise fans.

In an example embodiment, the one or more top reflection panels may comprise fans, wherein the fan speed is controlled by sensors.

In an example embodiment, a modular plant growing system may comprise individual modules, wherein the plant growing space defined the two or more substantially vertical light panels and a top panel may define a single module, and wherein subsequent modules may be attached either end to end or side by side.

In an example embodiment, the two or more substantially vertical light panels when fully extended may have openings below them to allowing air ventilation within the modular plant growing system.

In an example embodiment, the top reflection panels may be omitted.

In an example embodiment, a modular plant growing system may further comprises vertical support frame members that are configured to slidingly engage with the substantially vertical light panels.

In an example embodiment, the one or more LED light engines may be configured with guide tracks configured to slidingly engage with one or more vertical support frame members configured to support the substantially vertical light panels light panels, wherein the substantially vertical light panels may slide up or down on the one or more vertical support frame members.

In an example embodiment, the substantially vertical light panels may be configured to nest within one or more vertical support frame members that are configured to support the substantially vertical light panels light panels.

In an example embodiment of the described technology, a light panel may comprise a light panel configured to both emit and reflect light, and that is partially collapsible in at least one direction. The light panel may comprise one or more light engines and flexible reflection material may be connected between the light engines. The one or more light engines and the flexible reflection material may form a flexible light panel that both emits and reflects light, wherein the light panel may be partially collapsed in at least one direction.

In an example embodiment, the light engines may comprise elongated heat sinks with one or more LED light sources attached to the elongated heat sinks.

In an example embodiment, the flexible reflection material may be attached to one more sides of the elongated heat sinks.

In an example embodiment, the light engines may be configured in back to back pairs.

In an example embodiment, one or more light engines may be configured with diffuser lenses and reflector elements configured to direct light from a light source disposed within the light engine.

In an example embodiment, one or more light engines may comprise optical film configured with folds, therein providing a means of attachment to elongated heat sinks, and may also be able to provide different lens shape configurations.

In an example embodiment of the described technology, a modular micro-climate environment for growing plants is provided, and may comprise two or more side walls comprising light panels configured to both emit and reflect light, and may further comprise one or more top panels configured to reflect light. A single module is defined by the two side walls and a top panel, and wherein modules are configured to attach or be disposed to adjacent modules either end to end or side by side.

While certain implementations of the disclosed technology have been described in connection with what is presently considered to be the most practical implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description may use examples to disclose certain implementations of the disclosed technology, including the best mode, and may also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I Claim:

1. A modular plant growing system comprising:
two or more substantially vertical light panels, wherein each substantially vertical light panel comprises one or more LED light engines;
a support base attached directly or indirectly to each vertical light panel, wherein the support bases are configured to engage with bottom surfaces of plant growing containers; and
optional one or more top reflection panels configured to be disposed above the two or more substantially vertical light panels, the one or more top reflection panels comprising reflection material and at least one ventilation opening;
wherein a plant growing space is provided in the space defined by the two or more substantially vertical light panels and the one or more optional top reflection panels.

2. The modular plant growing system of claim 1, wherein the substantially vertical light panels are light panels that are at least partially collapsible in the vertical direction.

3. The modular plant growing system of claim 1, wherein the substantially vertical light panels are light panels that are at least partially collapsible in the vertical direction, and further comprise reflection material attached to the one or more LED light engines.

4. The modular plant growing system of claim 1, wherein the one or more LED light engines comprise lenses that direct the light predominantly at angles between 45 degrees and 0 degrees, wherein 45 degrees represents the axis emanating from the normal of the LED light source, and 0 degrees represents the vertical axis of the one or more substantially vertical light panels.

5. The modular plant growing system of claim 1, wherein the one or more top reflection panels comprise fans.

6. The modular plant growing system of claim 1, wherein the one or more top reflection panels comprise fans, wherein the fan speed is controlled by sensors.

7. The modular plant growing system of claim 1 comprises individual modules, wherein the plant growing space defined the two or more substantially vertical light panels and a top panel defines a single module, and wherein subsequent modules may be attached either end to end or side by side.

8. The modular plant growing system of claim 1, wherein the two or more substantially vertical light panels when fully extended have openings below them to allowing air ventilation within the modular plant growing system.

9. The modular plant growing system of claim 1, wherein the top reflection panels are omitted.

10. The modular plant growing system of claim 1 further comprises vertical support frame members that are configured to slidingly engage with the substantially vertical light panels.

11. The modular plant growing system of claim 1 wherein the one or more LED light engines are configured with guide tracks configured to slidingly engage with one or more vertical support frame members configured to support the substantially vertical light panels light panels, wherein the substantially vertical light panels may slide up or down on the one or more vertical support frame members.

12. The modular plant growing system of claim 1, wherein the substantially vertical light panels are configured to nest within one or more vertical support frame members that are configured to support the substantially vertical light panels light panels.

13. The modular plant growing system of claim 1, wherein the light panels have adjustable height.

14. A light panel comprising:
a light panel configured to both emit and reflect light;
a light panel that is partially collapsible in at least one direction;
the light panel comprising:
one or more light engines; and
flexible reflection material connected between the light engines;
wherein the one or more light engines and the flexible reflection material form a flexible light panel that both emits and reflects light, and wherein the light panel may be partially collapsed in at least one direction.

15. The light panel of claim 14, wherein the light engines comprise elongated heat sinks with one or more LED light sources attached to the elongated heat sinks.

16. The elongated heat sinks of claim 15, wherein the flexible reflection material is attached to one more sides of the elongated heat sinks.

17. The light panel of claim 14, wherein the light engines are configured in back to back pairs.

18. The light panel of claim 14, wherein one or more light engines are configured with diffuser lenses and reflector elements configured to direct light from a light source disposed within the light engine.

19. The light panel of claim 14, wherein the one or more light engines comprise optical film configured with folds, therein providing a means of attachment to elongated heat sinks, and also to provide different lens shape configurations.

20. A modular micro-climate environment for growing plants comprising:
two or more side walls comprising light panels configured to both emit and reflect light; and
one or more top panels configured to reflect light;
wherein a micro-climate plant growing space is provided, and a single module is defined by the two side walls and a top panel, and wherein modules are configured to attach or be disposed to adjacent modules either end to end or side by side.
